(19) United States
(12) Patent Application Publication
(10) Pub. No.: US 2025/0291632 A1
(43) Pub. Date: Sep. 18, 2025

(54) EDGE-ASSISTED ENERGY-AWARE AND COMMUNICATION-AWARE DYNAMIC COMPUTATIONAL TASK OFFLOADING STRATEGY

(71) Applicant: Toyota Motor Engineering & Manufacturing North America, Inc., Plano, TX (US)

(72) Inventors: Dawei Chen, Milpitas, CA (US); Qi Chen, San Jose, CA (US); Rohit Gupta, Santa Clara, CA (US); Kyungtae Han, Palo Alto, CA (US)

(73) Assignees: Toyota Motor Engineering & Manufacturing North America, Inc., Plano, TX (US); Toyota Jidosha Kabushiki Kaisha, Aichi-ken (JP)

(21) Appl. No.: 18/431,723

(22) Filed: Feb. 2, 2024

(51) Int. Cl. G06F 9/48; B60K 15/03; B60L 58/12; G06F 9/54

(52) U.S. Cl. CPC G06F 9/4893; G06F 9/545; B60K 15/03; B60K 2015/03217; B60L 58/12; G06F 2209/485; G06F 2209/549

(57) ABSTRACT

A method is provided including receiving task information about a computational task associated with a vehicle to be performed; receiving information about an amount of gasoline or electrical charge remaining on the vehicle; determining a complexity of the computational task based on the task information; and determining whether to perform the computational task locally by the vehicle or remotely by a remote computing device based on the amount of gasoline or electrical charge remaining on the vehicle and the complexity of the computational task.

### TECHNICAL FIELD

The present specification relates to performing computational tasks for vehicles, and more particularly to edge-assisted energy-aware and communication-aware dynamic computational task offloading strategy.

### BACKGROUND

Autonomous and semi-autonomous vehicles often need to perform a variety of computational tasks in order to perform autonomous or semi-autonomous driving. While it may be possible to perform such tasks locally with a vehicle, it may be beneficial for the vehicle to offload certain tasks to remote computing device such as an edge server. This may allow the vehicle to conserve resources while the task is performed remotely. However, this may increase the latency at which the computational task is performed. Accordingly, there may be certain instances when computational tasks or portions thereof should be offloaded to an edge server, and other instances when computational tasks or portions thereof should be performed locally by the vehicle. As such, a need exists for an edge-assisted energy-aware and communication-aware dynamic computational task offloading strategy.

### SUMMARY

In an embodiment, a method may include receiving task information about a computational task associated with a vehicle to be performed, receiving information about an amount of gasoline or electrical charge remaining on the vehicle, determining a complexity of the computational task based on the task information, and determining whether to perform the computational task locally by the vehicle or remotely by a remote computing device based on the amount of gasoline or electrical charge remaining on the vehicle and the complexity of the computational task.

In another embodiment, a computing device may comprise a processor configured to receive task information about a computational task associated with a vehicle to be performed, receive information about an amount of gasoline or electrical charge remaining on the vehicle, determine a complexity of the computational task based on the task information, and determine whether to perform the computational task locally by the vehicle or remotely by a remote computing device based on the amount of gasoline or electrical charge remaining on the vehicle and the complexity of the computational task.

In another embodiment, a system may include a vehicle, a road-side unit, and an edge server. The vehicle may transmit, to the road-side unit, task information about a computational task associated with the vehicle to be performed, and an amount of gasoline or electrical charge remaining on the vehicle. The road-side unit may determine a complexity of the computational task based on the task information, and determine whether to perform the computational task locally by the vehicle or remotely by the edge server based on the amount of gasoline or electrical charge remaining on the vehicle and the complexity of the computational task.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 schematically depicts a system for performing an edge-assisted energy-aware and communication-aware dynamic computational task offloading strategy, according to one or more embodiments shown and described herein;

FIG. 2 schematically depicts a vehicle system, according to one or more embodiments shown and described herein;

FIG. 3 schematically depicts memory modules of the vehicle system of FIG. 2, according to one or more embodiments shown and described herein;

FIG. 4 schematically depicts a road-side unit, according to one or more embodiments shown and described herein;

FIG. 5 schematically depicts an edge server, according to one or more embodiments shown and described herein;

FIG. 6 depicts a flowchart of a method that may be performed by the vehicle system of FIG. 2, according to one or more embodiments shown and described herein;

FIG. 7 depicts a flowchart of a method that may be performed by the road-side unit of FIG. 4, according to one or more embodiments shown and described herein; and

FIG. 8 depicts a flowchart of a method that may be performed by the edge server of FIG. 5, according to one or more embodiments shown and described herein.

### DETAILED DESCRIPTION

The embodiments disclosed herein include a method and system for edge-assisted energy-aware and communication-aware dynamic computational task offloading strategy. When an autonomous or semi-autonomous vehicle needs to perform a computational task, the vehicle may transmit information about the task to be performed and information about the vehicle to a road-side unit. The information about the task may indicate the functions to be performed, and may also indicate certain constraints such as a maximum allowable latency. The information about the vehicle may include the amount of gas or electrical charge remaining in the vehicle, the amount of CPU usage by the vehicle, a status of a communication channel with an edge server, and the like.

After receiving this information, the road-side unit may determine whether all or portions of the task should be performed locally by the vehicle or remotely by the edge server. The road-side unit may consider factors such as the complexity of the task, the resources of the vehicle and the edge server, and the constraints associated with the task. The road-side unit may also determine details associated with the performance of the task, such as whether data associated with the task should be encoded, and the algorithm or model to be used to perform the task. The task may then be performed either locally by the vehicle or remotely by the edge server.

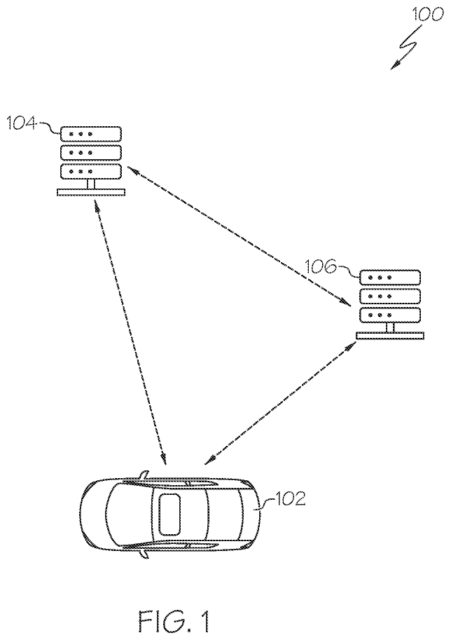

Turning now to the figures, FIG. 1 schematically depicts a system for determining a task offloading strategy, as disclosed herein. In the example of FIG. 1, a system 100 includes a vehicle 102, a road-side unit 104, and an edge server 106.

In the example of FIG. 1, the vehicle 102 is a connected vehicle. A connected vehicle is able to communicate remotely with systems outside of the vehicle (e.g., with the road-side unit 104 and/or the edge server 106). In the example of FIG. 1, the road-side unit 104 and the edge server 106 may be communicatively coupled to the vehicle 102.

In the example of FIG. 1, the vehicle 102 may be an autonomous or semi-autonomous vehicle. That is, the vehicle 102 may autonomously perform some or all driving tasks without intervention by the driver. As such, the vehicle 102 may perform a number of computational tasks in support of autonomous or semi-autonomous driving, such as navigation, trajectory planning, vehicle tracking, lane changing, object identification, object classification, and the like. The vehicle 102 may include an actuator for driving the vehicle, such as a motor, an engine, or any other powertrain.

In the example of FIG. 1, the road-side unit 104 may comprise a computing device located near a road along which the vehicle 102 travels. The vehicle 102 may be communicatively coupled to the road-side unit 104 such that the vehicle 102 and the road-side unit 104 may transmit information between each other. A plurality of road-side units may be located at various locations along one or more roads such that the vehicle 102 may be in range of different road-side units as it drives along the one or more roads. In the illustrated example, the vehicle 102 may transmit vehicle information and task information to the road-side unit 104, as disclosed herein. The road-side unit 104 may determine whether tasks should be performed locally by the vehicle 102 or remotely by the edge server 106, as disclosed herein.

In the example of FIG. 1, the edge server 106 may be communicatively coupled to the vehicle 102 and may perform one or more computational tasks for the vehicle 102, as disclosed herein. In particular, when the road-side unit 104 determines that a computational task should be performed remotely by the edge server 106, rather than locally by the vehicle 102, the edge server 106 may perform the task. In some examples, the functions of the road-side unit 104 may be combined with the edge server 106 or the functions of the edge server 106 may be combined with the road-side unit 104. That is, in some examples, a single computing device (e.g., an edge server) may determine whether a task should be performed locally or remotely, and may also perform the task if it determined that the task should be performed remotely from the vehicle 102.

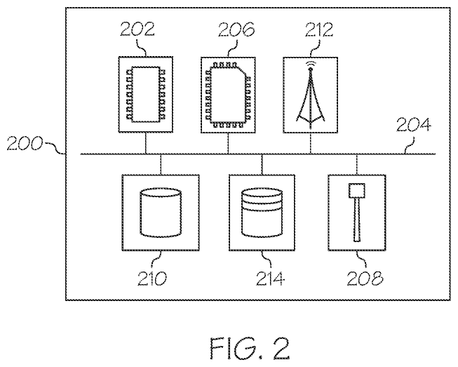

FIG. 2 depicts an example vehicle system 200 that may be included in the vehicle 102 of FIG. 1. In the example of FIG. 2, the vehicle system 200 includes one or more processors 202, a communication path 204, one or more memory modules 206, a satellite antenna 208, one or more vehicle sensors 210, a network interface hardware 212, and a data storage component 214, the details of which will be set forth in the following paragraphs.

Each of the one or more processors 202 may be any device capable of executing machine readable and executable instructions. Accordingly, each of the one or more processors 202 may be a controller, an integrated circuit, a microchip, a computer, or any other computing device. The one or more processors 202 are coupled to a communication path 204 that provides signal interconnectivity between various modules of the vehicle system 200. Accordingly, the communication path 204 may communicatively couple any number of processors 202 with one another, and allow the modules coupled to the communication path 204 to operate in a distributed computing environment. Specifically, each of the modules may operate as a node that may send and/or receive data. As used herein, the term “communicatively coupled” means that coupled components are capable of exchanging data signals with one another such as, for example, electrical signals via conductive medium, electromagnetic signals via air, optical signals via optical waveguides, and the like.

Accordingly, the communication path 204 may be formed from any medium that is capable of transmitting a signal such as, for example, conductive wires, conductive traces, optical waveguides, or the like. In some embodiments, the communication path 204 may facilitate the transmission of wireless signals, such as Wi-Fi, Bluetooth®, Near Field Communication (NFC) and the like. Moreover, the communication path 204 may be formed from a combination of mediums capable of transmitting signals. In one embodiment, the communication path 204 comprises a combination of conductive traces, conductive wires, connectors, and buses that cooperate to permit the transmission of electrical data signals to components such as processors, memories, sensors, input devices, output devices, and communication devices. Accordingly, the communication path 204 may comprise a vehicle bus, such as for example a LIN bus, a CAN bus, a VAN bus, and the like. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium.

The vehicle system 200 includes one or more memory modules 206 coupled to the communication path 204. The one or more memory modules 206 may comprise RAM, ROM, flash memories, hard drives, or any device capable of storing machine readable and executable instructions such that the machine readable and executable instructions can be accessed by the one or more processors 202. The machine readable and executable instructions may comprise logic or algorithm(s) written in any programming language of any generation (e.g., 1GL, 2GL, 3GL, 4GL, or 5GL) such as, for example, machine language that may be directly executed by the processor, or assembly language, object-oriented programming (OOP), scripting languages, microcode, etc., that may be compiled or assembled into machine readable and executable instructions and stored on the one or more memory modules 206. Alternatively, the machine readable and executable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components.

Referring still to FIG. 2, the vehicle system 200 comprises a satellite antenna 208 coupled to the communication path 204 such that the communication path 204 communicatively couples the satellite antenna 208 to other modules of the vehicle system 200. The satellite antenna 208 is configured to receive signals from global positioning system satellites. Specifically, in one embodiment, the satellite antenna 208 includes one or more conductive elements that interact with electromagnetic signals transmitted by global positioning system satellites. The received signal is transformed into a data signal indicative of the location (e.g., latitude and longitude) of the satellite antenna 208, and consequently, the vehicle containing the vehicle system 200.

The vehicle system 200 comprises one or more vehicle sensors 210. Each of the one or more vehicle sensors 210 is coupled to the communication path 204 and communicatively coupled to the one or more processors 202. The one or more vehicle sensors 210 may include, but are not limited to, LiDAR sensors, RADAR sensors, optical sensors (e.g., cameras, laser sensors), proximity sensors, location sensors (e.g., GPS modules), and the like. The vehicle sensors 210 may collect data that may be used to autonomously drive the vehicle. The vehicle sensors 210 may also detect information about the status of the vehicle 102, such as the amount of gasoline remaining (for a gas-powered vehicle), the amount of electrical charge remaining (for an electrical vehicle), and the status of the communication channel between the vehicle 102 and the edge server 106.

Still referring to FIG. 2, the vehicle system 200 comprises network interface hardware 212 for communicatively coupling the vehicle system 200 to the road-side unit 104 and the edge server 106. The network interface hardware 212 can be communicatively coupled to the communication path 204 and can be any device capable of transmitting and/or receiving data via a network. Accordingly, the network interface hardware 212 can include a communication transceiver for sending and/or receiving any wired or wireless communication. For example, the network interface hardware 212 may include an antenna, a modem, LAN port, Wi-Fi card, WiMax card, mobile communications hardware, near-field communication hardware, satellite communication hardware and/or any wired or wireless hardware for communicating with other networks and/or devices.

Still referring to FIG. 2, the vehicle system 200 comprises a data storage component 214. The data storage component 214 may store data used by various components of the vehicle system 200. In addition, the data storage component 214 may store data collected by the vehicle sensors 210 and data received from the road-side unit 104 and/or the edge server 106.

In some embodiments, the vehicle system 200 may be communicatively coupled to the road-side unit 104 and/or the edge server 106 by a network. In one embodiment, the network may include one or more computer networks (e.g., a personal area network, a local area network, or a wide area network), cellular networks, satellite networks and/or a global positioning system and combinations thereof. Accordingly, the vehicle system 200 can be communicatively coupled to the network via a wide area network, via a local area network, via a personal area network, via a cellular network, via a satellite network, etc. Suitable local area networks may include wired Ethernet and/or wireless technologies such as, for example, Wi-Fi. Suitable personal area networks may include wireless technologies such as, for example, IrDA, Bluetooth®, Wireless USB, Z-Wave, ZigBee, and/or other near field communication protocols. Suitable cellular networks include, but are not limited to, technologies such as LTE, WiMAX, UMTS, CDMA, and GSM.

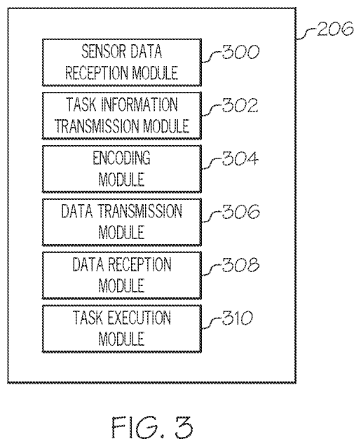

Now referring to FIG. 3, the memory modules 206 of the vehicle system 200 are schematically shown. The one or more memory modules 206 include a sensor data reception module 300, a task information transmission module 302, an encoding module 304, a data transmission module 306, a data reception module 308, and a task execution module 310. Each of the sensor data reception module 300, the task information transmission module 302, the encoding module 304, the data transmission module 306, the data reception module 308, and the task execution module 310 may be a program module in the form of operating systems, application program modules, and other program modules stored in the one or more memory modules 206. In some embodiments, the program module may be stored in a remote storage device that may communicate with the vehicle system 200. Such a program module may include, but is not limited to, routines, subroutines, programs, objects, components, data structures and the like for performing specific tasks or executing specific data types as will be described below.

The sensor data reception module 300 may receive data from the vehicle sensors 210. In particular, the sensor data reception module 300 may receive information about the state of the vehicle 102 and the surrounding environment. For example, the sensor data reception module 300 may receive data about the amount of gasoline or electrical charge remaining for the vehicle 102, and the CPU utilization of the vehicle 102. The sensor data reception module 300 may also receive information about the mileage of the vehicle, the location of the vehicle, and a planned destination of the vehicle. The sensor data reception module 300 may also receive data about surrounding vehicles or pedestrians, such as their locations and speeds. The sensor data reception module 300 may also receive data about weather conditions, a speed limit, and other driving restrictions. The sensor data reception module 300 may also receive information about the status of a communication channel between the vehicle 102 and the edge server 106 (e.g., a bandwidth or transmission speed for data transmitted between the vehicle 102 and the edge server 106). The information received by the sensor data reception module 300 may be used by the road-side unit 104 to determine whether a task is to be performed by the vehicle 102 or by the edge server 106.

The task information transmission module 302 may transmit information about a task to be performed to the road-side unit 104 and to the edge server 106. As discussed above, the vehicle 102 may perform a variety of computational tasks in order to perform autonomous or semi-autonomous driving. It may be beneficial to perform certain tasks locally by the vehicle 102 and other tasks remotely by the edge server 106. As such, when a task is to be performed, the task information transmission module 302 may transmit information about the task to the road-side unit 104. The road-side unit 104 may then determine whether the task should be performed by the vehicle 102 or by the edge server 106, as discussed in further detail below. Furthermore, upon determination that the task should be performed remotely by the edge server 106, the task information transmission module 302 may transmit information about the task to be performed to the edge server 106.

The task information transmission module 302 may transmit information about the task to be performed, such as the type and amount of data to be processed, the result to be obtained, the type of algorithm or model to be used, and the like. The task information transmission module 302 may also transmit constraints associated with the task to be performed, such as a maximum allowable latency. The task information transmission module 302 may also transmit information about the vehicle 102 collected by the sensor data reception module 300 as discussed above, such as the vehicle's destination, CPU utilization, and the amount of gasoline or electrical charge remaining in the vehicle. The task information transmission module 302 may also transmit information about a location of the vehicle 102 and a destination of the vehicle 102.

The encoding module 304 may encode data to be used to perform the computational task. As discussed above, in some circumstances, the vehicle 102 may transmit encoded data to be processed by the edge server 106, and in other circumstances, the vehicle 102 may transmit un-encoded data to be processed by the edge server 106. The road-side unit 104 may determine whether the data should be encoded, as discussed in further detail below. If the road-side unit 104 determines that the data to be processed should be encoded, then the encoding module 304 may encode the data to be processed. If the road-side unit 104 determines that the data to be processed should not be encoded, then the encoding module 304 does not encode the data.

In some examples, the encoding module 304 may compress the data associated with the computational task, which may reduce the amount of data to be transmitted to the edge server 106. In some examples the decision on whether to encode data and the type of encoding may depend on the task complexity and latency requirements. For example, if a lower latency is required, the encoding module 304 may encode the data to reduce data transmission time and thereby latency. However, encoding data also increases the computational resources of the vehicle 102, which are needed to perform the encoding. As such, if the computational resources of the vehicle 102 are low, the encoding module 304 may not encode the data, and the vehicle 102 may transmit un-encoded data to the edge server 106.

In some examples, the type of encoding or compression performed by the encoding module 304 may depend on the type of data to be transmitted. For example, for image data, the encoding module 304 may use entropy coding, Shannon-Fano coding, Huffman Coding, Fast Fourier Transform, or Discrete Cosine Transform. A rate indicator for these types of encodings may comprise resolution, feature space vectors, and latent space. For audio data, the encoding module 304 may use Modified Discrete Cosine Transform, linear predictive coding, and quantization. The rate indicator for these types of encodings may comprise bit rate or fidelity. For video data, the encoding module 304 may use H.264 or motion-compensated DCT video coding. The rate indicator for these encodings may comprise resolution, compression factor, or bit rate.

The data transmission module 306 may transmit data associated with the task to be performed to the edge server 106 upon determination that the edge server 106 should remotely perform the task. The data transmission module 306 may transmit either encoded data or un-encoded data. The type of data transmitted by the data transmission module 306 may depend upon the type of task to be performed. For example, for path planning, the data transmission module 306 may transmit a departure location, a destination location, and a map of the city being traveled. For real-time path monitoring, the data transmission module 306 may transmit traffic data. For safety guard, the data transmission module 306 may transmit locations and speeds of surrounding pedestrians and vehicles. For performing a lane change, the data transmission module 306 may transmit a current position and driving speed of the vehicle 102, speeds and distances of surrounding vehicles, and current weather conditions and speed limit. In other examples, other types of data may be transmitted for other types of computational tasks.

The data reception module 308 may receive data from the edge server 106 after the edge server 106 performs a requested task. As discussed above, in some circumstances, the edge server 106 may remotely perform a computational task requested by the vehicle 102. As such, after the edge server 106 performs the task, the edge server 106 may transmit the resulting data to the vehicle 102, which may be received by the data reception module 308. The vehicle 102 may then utilize the received data to perform autonomous or semi-autonomous driving. For example, for a path planning task, the data reception module 308 may receive a determined path. For other types of tasks, the data reception module 308 may receive other types of data resulting from the task performance. In some examples, the received data may cause the vehicle 102 to perform one or more autonomous driving maneuvers based on the data received.

The task execution module 310 may perform local execution of a computational task. As discussed above, in some circumstances, the road-side unit 104 may determine that the vehicle 102 should perform local execution of the task, rather than the task being performed by the edge server 106. In these circumstances, the task execution module 310 may execute the task using the local resources of the vehicle 102. In particular, task execution module 310 may select an appropriate algorithm or machine learning model to perform the task, and utilize the selected algorithm or machine learning model to perform the task. The vehicle 102 may then utilize the results of the task to perform autonomous or semi-autonomous driving. In some examples, the model or algorithm to be used to perform the task may be selected by the road-side unit 104, as discussed in further detail below.

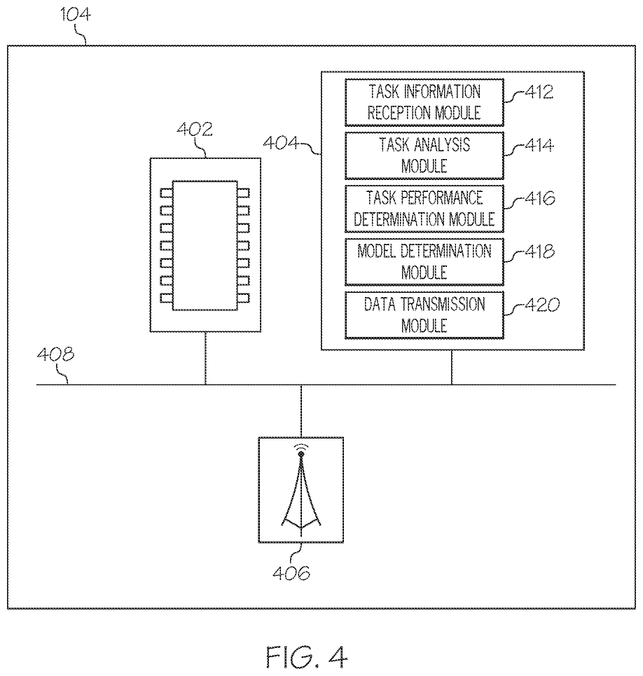

Now referring to FIG. 4, the road-side unit 104 comprises one or more processors 402, one or more memory modules 404, network interface hardware 406, and a communication path 408. The one or more processors 402 may be a controller, an integrated circuit, a microchip, a computer, or any other computing device. The one or more memory modules 404 may comprise RAM, ROM, flash memories, hard drives, or any device capable of storing machine readable and executable instructions such that the machine readable and executable instructions can be accessed by the one or more processors 402.

The network interface hardware 406 can be communicatively coupled to the communication path 408 and can be any device capable of transmitting and/or receiving data via a network. Accordingly, the network interface hardware 406 can include a communication transceiver for sending and/or receiving any wired or wireless communication. For example, the network interface hardware 406 may include an antenna, a modem, LAN port, Wi-Fi card, WiMax card, mobile communications hardware, near-field communication hardware, satellite communication hardware and/or any wired or wireless hardware for communicating with other networks and/or devices. The network interface hardware 406 of the road-side unit 104 may transmit and receive data to and from the vehicle 102 and/or the edge server 106.

The one or more memory modules 404 include a task information reception module 412, a task analysis module 414, a task performance determination module 416, a model determination module 418, and a data transmission module 420. Each of the task information reception module 412, the task analysis module 414, the task performance determination module 416, the model determination module 418, and the data transmission module 420 may be a program module in the form of operating systems, application program modules, and other program modules stored in the one or more memory modules 404. Such a program module may include, but is not limited to, routines, subroutines, programs, objects, components, data structures and the like for performing specific tasks or executing specific data types as will be described below.

The task information reception module 412 may receive information about a computational task to be performed from the vehicle 102. In particular, the task information reception module 412 may receive the task information transmitted by the task information transmission module 302 of the vehicle 102. As discussed above, the task information transmission module 302 may transmit information about the task to be performed and information about the vehicle 102. This information may be received by the task information reception module 412. The road-side unit 104 may utilize this information to determine whether the computational task to be performed should be performed locally by the vehicle 102 or remotely by the edge server 106, as disclosed herein.

The task analysis module 414 may analyze the task received by the task information reception module 412, as disclosed herein. In particular, the task analysis module 414 may determine a complexity of the task, and a latency of performing the task. The complexity of the task (i.e., task complexity) may comprise an indication of a difficulty of performing the task. In some examples, the task complexity may be based on the amount of computing resources needed to perform the task. In other examples, the task complexity may be based on an amount of time needed to perform the task.

In some examples, the task analysis module 414 may utilize a look-up table to determine task complexity. In these examples, each type of task may be assigned a number associated with its complexity (e.g., a number between 0-10), which may be stored in the look-up table. When the task analysis module 414 analyzes a task, it may look up the task in the look-up table and assign the appropriate number to the task. For example, path planning may have a task complexity of 2, real-time path monitoring may have a task complexity of 5, safety guarding may have a task complexity of 8, and lane changing may have a task complexity of 8. However, these numbers are merely exemplary, and these tasks and other tasks may have different task complexity values.

The task performance determination module 416 may determine whether the task should be performed locally by the vehicle 102 or remotely by the edge server 106, as disclosed herein. In addition, if it is determined that the task should be performed remotely by the edge server 106, the task performance determination module 416 may determine whether the vehicle should encode data to reduce the size of the data before offloading the data to the edge server 106. In one example, the task performance determination module 416 may initially determine whether the vehicle 102 is able to locally perform the task. Performing the task locally by the vehicle 102 will utilize certain computing and energy resources of the vehicle 102. As such, performing the computing task may prevent the vehicle 102 from performing other computing tasks and/or deprive the vehicle 102 of sufficient energy resources to reach a planned destination.

Accordingly, the task performance determination module 416 may determine the amount of computing resources that the vehicle 102 will consume in performance of the task. The task performance determination module 416 may make this determination based on the complexity of the task determined by the task analysis module 414. The more complex the task to be performed, the more computing resources will be used to perform the task. In some examples, the task performance determination module 416 may utilize a look-up table to determine the amount of computing resources of the vehicle 102 needed to perform the task. For example, if the task complexity ranges from a value of 0-10, as discussed above, a look-up table may indicate an amount of computing resources of the vehicle 102 needed to perform tasks of each task complexity value.

The task performance determination module 416 may also determine the amount of energy resources needed for the vehicle 102 to perform the task. When performing the task, the vehicle 102 will utilize some amount of energy (either gasoline or electrical charge) to perform the task. The task performance determination module 416 may determine the amount of energy resources needed for the vehicle 102 to perform the task based on the task complexity, as determined by the task analysis module 414. In some examples, the task performance determination module 416 may utilize a look-up table to determine the amount of energy resources needed for the vehicle 102 to perform the task. For example, if the task complexity ranges from a value of 0-10, as discussed above, a look-up table may indicate an amount of energy resources needed for the vehicle 102 to perform tasks of each task complexity value.

After determining the amount of computing resources and the amount of energy resources needed for the vehicle 102 to perform the task, the task performance determination module 416 may determine whether the vehicle 102 has sufficient computing resources and energy resources to perform the task locally. In particular, the task performance determination module 416 may determine whether the vehicle 102 has sufficient computing resources to perform the task based on the CPU utilization of the vehicle 102, received by the task information reception module 412, and the amount of computing resources needed to perform the task, as determined by the task performance determination module 416. For example, the CPU utilization of the vehicle 102 may indicate the amount of available computing resources that the vehicle 102 has. As such, the task performance determination module 416 may determine whether the available computing resources of the vehicle 102 is greater than the amount of computing resources needed to perform the task. If so, then the task performance determination module 416 may determine that the vehicle 102 has sufficient resources to perform the task.

The task performance determination module 416 may determine whether the vehicle 102 has sufficient energy resources to perform the task based on the amount of remaining gasoline (for gas-powered vehicles) or electrical charge (for electric vehicles) remaining. In particular, as discussed above, the task information reception module 412 may receive the amount of gasoline or electrical charge remaining in the vehicle 102, as well as the current location and planned destination of the vehicle 102. As such, the task performance determination module 416 may determine the amount of energy resources needed for the vehicle 102 to travel from its current location to the planned destination. The task performance determination module 416 may then determine whether the amount of gasoline or electrical charge remaining in the vehicle 102 is greater than the energy resources needed for the vehicle 102 to reach the destination and the amount of energy resources needed to perform the task combined. If so, then the task performance determination module 416 may determine that the vehicle 102 has sufficient energy resources to perform the task.

If the task performance determination module 416 determines that the vehicle 102 has sufficient computing and energy resources to perform the task, the task performance determination module 416 may determine a latency for the vehicle 102 to perform the task. That is, the task performance determination module 416 may determine an amount of time for the vehicle 102 to locally perform the task. The task performance determination module 416 may make this determination module based on the complexity of the task. That is, more complex tasks may take longer to perform than less complex tasks. In some examples, the task performance determination module 416 may utilize a look-up table to determine the latency of performing the task locally by the vehicle 102 based on the task complexity value determined by the task analysis module 414.

The task performance determination module 416 may also determine whether the vehicle 102 has sufficient computing resources and energy resources to encode the data associated with the computational task. As discussed above, the encoding module 304 may encode the data associated with the computational task to reduce the total amount of data to be transmitted to the edge server 106 if the task is to be performed remotely by the edge server 106. However, encoding the data requires certain computing resources and energy resources. As such, the task performance determination module 416 may determine the amount of computing resources and energy resources needed for the vehicle 102 to encode the data. The task performance determination module 416 may then determine whether the vehicle 102 has sufficient computing resources and energy resources to encode the data associated with the task based on the amount computing resources and energy resources available to the vehicle 102, as received by the task information reception module 412.

The task performance determination module 416 may also determine a latency of performing the task remotely by the edge server 106, as disclosed herein. The task performance determination module 416 may determine a transmission time needed for the vehicle 102 to transmit the data associated with the task to the edge server 106. This transmission time may be determined based on the amount of data to be transmitted, and also based on the quality of the communication channel or protocol used by the edge server 106. As discussed above, the vehicle 102 may transmit information about the communication channel between the vehicle 102 and the edge server 106. This information may include a transmission rate for transmitting data between the vehicle 102 and the edge server 106. As such, the task performance determination module 416 may determine the amount of time required to transmit the data associated with the task based on this data transmission rate.

The task performance determination module 416 may similarly determine a transmission time required for the edge server 106 to transmit the output of the task performance (e.g., the results determined after performing the task) back to the vehicle 102. In particular, the task performance determination module 416 may determine an expected amount of data to be transmitted by the edge server 106 after performing the task, which may be based on the task complexity or specific task to be performed. The task performance determination module 416 may then determine a transmission time for this amount of data to be transmitted via the transmission bandwidth of the edge server 106. In some examples, the data transmission rate from the vehicle 102 to the edge server 106 may be different than the data transmission rate from the edge server 106 to the vehicle 102.

In addition to determining data transmission times, the task performance determination module 416 may determine an amount of time needed for the edge server 106 to perform the task. This determination may be based on the task complexity and the computing resources of the edge server 106. In particular, the road-side unit 104 may store information about the computing resources (e.g., computing speed) of the edge server 106. In some examples, the task performance determination module 416 may determine different amounts of time needed for the edge server 106 to perform the task with data encoding and without data encoding.

After determining whether the vehicle 102 has sufficient computing and energy resources to perform the task, whether the vehicle 102 has sufficient computing and energy resources to encode the data associated with the task, a latency associated with the vehicle 102 performing the task locally, and a latency associated with the edge server 106 remotely performing the task, the task performance determination module 416 may determine whether the task should be performed locally by the vehicle or remotely by the edge server 106, as disclosed herein. If the vehicle 102 does not have sufficient computing or energy resources to perform the task locally, then the task performance determination module 416 determines that the task should be performed remotely by the edge server 106. However, if the vehicle 102 has sufficient computing and energy resources to perform the task locally, then the task performance determination module 416 may determine that the task should be performed locally by the vehicle 102 or remotely by the edge server 106, as disclosed herein.

If the vehicle 102 has sufficient computing and energy resources to perform the task locally, then the task performance determination module 416 determines whether the vehicle 102 has sufficient computing and energy resources to encode the data associated with the task. If the vehicle 102 does not have sufficient computing resources or energy resources to encode the data, then the task performance determination module 416 determines the total latency for the vehicle 102 to locally perform the task and the total latency for the edge server 106 to remotely perform the task with un-encoded data. The task performance determination module 416 then determines that whichever energy has the lowest latency, between the vehicle 102 and the edge server 106, should perform the task.

If the task performance determination module 416 determines that the vehicle 102 has sufficient computing and energy resources to perform the task, the task performance determination module 416 then determines the total latency for the vehicle 102 to perform the task locally, the total latency for the edge server 106 to remotely perform the task with data encoding, and the totally latency for the edge server 106 to remotely perform the task without data encoding. The task performance determination module 416 then selects the lowest latency option.

The model determination module 418 determines an appropriate algorithm or model to perform the task based on the type of task to be performed. In one example, the model determination module 418 may determine a larger machine learning model (e.g., a neural network having more layers and/or neurons) the more complex the task is. In another example, if the task requires image processing, the model determination module 418 may select a convolutional neural network to perform the task. In another example, if the task involves voice processing, the model determination module 418 may select a language model.

The data transmission module 420 may transmit, to the vehicle 102, the determinations made by the task performance determination module 416 as to whether the task should be performed locally by the vehicle 102 or remotely by the edge server 106. The data transmission module 420 may also transmit, to the vehicle 102, the determination made by the task performance determination module 416 as to whether the data associated with the task should be encoded. The data transmission module 420 may also transmit, to the vehicle 102, the determination made by the model determination module 418 as to the model or algorithm that should be used to perform the task.

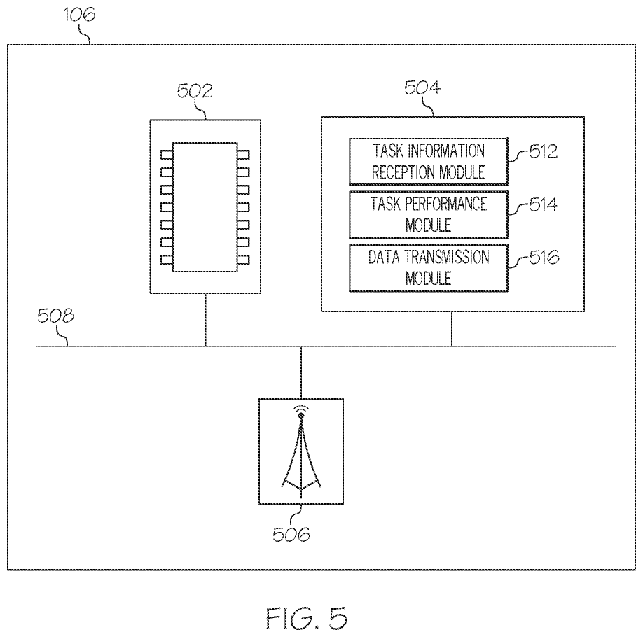

Now referring to FIG. 5, the edge server 106 comprises one or more processors 502, one or more memory modules 504, network interface hardware 506, and a communication path 508. The one or more processors 502 may be a controller, an integrated circuit, a microchip, a computer, or any other computing device. The one or more memory modules 504 may comprise RAM, ROM, flash memories, hard drives, or any device capable of storing machine readable and executable instructions such that the machine readable and executable instructions can be accessed by the one or more processors 502.

The network interface hardware 506 can be communicatively coupled to the communication path 508 and can be any device capable of transmitting and/or receiving data via a network. Accordingly, the network interface hardware 506 can include a communication transceiver for sending and/or receiving any wired or wireless communication. For example, the network interface hardware 506 may include an antenna, a modem, LAN port, Wi-Fi card, WiMax card, mobile communications hardware, near-field communication hardware, satellite communication hardware and/or any wired or wireless hardware for communicating with other networks and/or devices. The network interface hardware 506 of the edge server 106 may transmit and receive data to and from the vehicle 102 and/or the road-side unit 104.

The one or more memory modules 504 include a task information reception module 512, a task performance module 514, and a data transmission module 516. Each of the task information reception module 512, the task performance module 514, and the data transmission module 516 may be a program module in the form of operating systems, application program modules, and other program modules stored in the one or more memory modules 504. Such a program module may include, but is not limited to, routines, subroutines, programs, objects, components, data structures and the like for performing specific tasks or executing specific data types as will be described below.

The task information reception module 512 may receive information about a computational task to be performed from the vehicle 102. In particular, the vehicle 102 may transmit the task information when it is determined that the edge server 106 should remotely perform the task, as discussed above. The task information reception module 512 may receive the data transmitted by the task information transmission module 302 of the vehicle 102. As discussed above, the task information transmission module 302 of the vehicle 102 may transmit information about the task to be performed. In addition, the data transmission module 306 may transmit the data associated with the task to be performed. This data may be either encoded or un-encoded as discussed above. The task information transmission module 302 of the vehicle 102 may also transmit information about the model or algorithm to be used to perform the task, as determined by the model determination module 418 of the road-side unit 104. All of this information and data may be received by the task information reception module 512.

The task performance module 514 may perform the computational task based on the information received by the task information reception module 512. In particular, the task performance module 514 may use the specified model or algorithm to perform the specified task based on the encoded or un-encoded data. After the task performance module 514 performs the task, the results or output of the task may be transmitted by the data transmission module 516 to the vehicle 102.

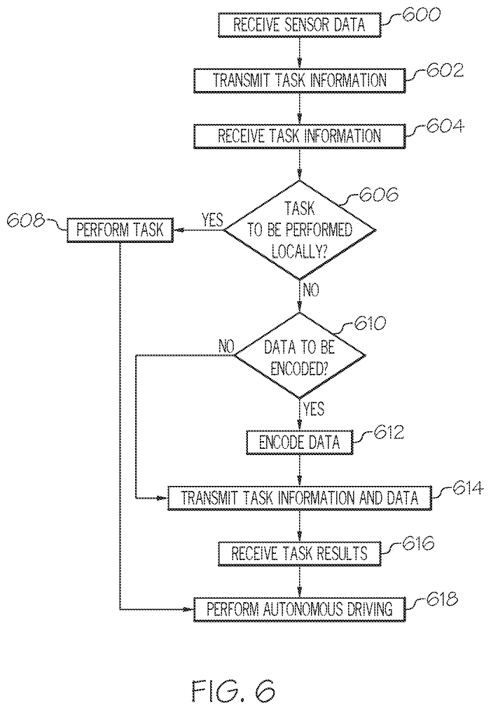

FIG. 6 depicts a flowchart of an example method that may be performed by the vehicle system 200 of the vehicle 102. At step 600, the sensor data reception module 300 receives sensor data. The sensor data may comprise information about the status of the vehicle 102, information about the status of a communication channel with the edge server 106, and information about the surrounding environment of the vehicle 102.

At step 602, the task information transmission module 302 transmits task information to the road-side unit 104. The task information may include details about a computational task to be performed. The task information may also include information about the status of the vehicle 102 and the status of the communication channel with the edge server 106. The road-side unit 104 may utilize this information to determine whether the task should be performed locally by the vehicle 102 or remotely by the edge server 106, as discussed above.

At step 604, the data reception module 308 receives information from the road-side unit 104 indicating whether the computational task should be performed locally by the vehicle 102 or remotely by the edge server 106. The data reception module 308 may also receive information from the road-side unit 104 indicating the model or algorithm that should be used to perform the task.

At step 606, the data reception module 308 determines whether the task is to be performed locally by the vehicle 102 or remotely by the edge server 106, based on the information received from the road-side unit 104. If the task is to be performed locally by the vehicle 102 (Yes at step 606), then at step 608, the task execution module 310 performs the task using the model or algorithm indicated by the road-side unit 104. Control then passes to step 618.

If the task is to be performed remotely by the edge server 106 (No at step 606), then at step 610, the data reception module 308 determines whether the data associated with the task should be encoded, based on the information received by the road-side unit 104. If the data should be encoded (Yes at step 610), then at step 612, the encoding module 304 encodes the data associated with the task. Control then passes to step 614.

At step 614, after the data is encoded, or upon determination that the data should not be encoded (No at step 610), the data transmission module 306 transmits the task information and the data associated with the task (either encoded or un-encoded) to the edge server 106. The edge server 106 may then perform the task based on the task information and transmit the results of the task back to the vehicle 102.

At step 616, the data reception module 308 receives the results of the performed task from the edge server 106. Then, at step 618, the vehicle 102 performs one or more autonomous or semi-autonomous driving maneuvers based on the results of the performed task.

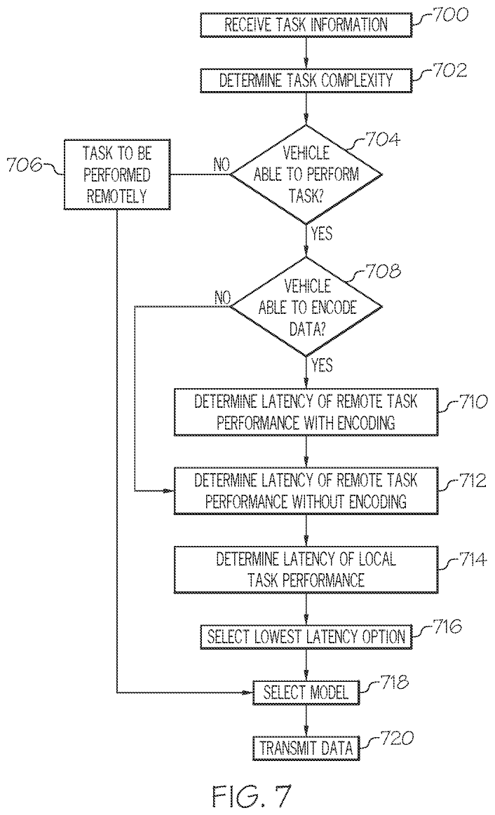

FIG. 7 depicts a flowchart of an example method that may be performed by the road-side unit 104. At step 700, the task information reception module 412 receives task information from the vehicle 102. The received task information may comprise information about the task to be performed, information about the status of the vehicle 102, and information about the status of the communication channel between the vehicle 102 and the edge server 106. At step 702, the task analysis module 414 determines a complexity of the task based on the task information received by the task information reception module 412 from the vehicle 102.

At step 704, the task performance determination module 416 determines whether the vehicle 102 has sufficient computing resources and sufficient energy resources to perform the task locally. In particular, the task performance determination module 416 determines whether the vehicle 102 has sufficient computing and energy resources to perform the task based on the CPU utilization of the vehicle 102, the amount of gasoline or electrical charge remaining on the vehicle 102, the vehicle destination, and the complexity of the task.

If the vehicle 102 does not have sufficient computing and energy resources to perform the task locally (No at step 704), then the task performance determination module 416 determines, at step 706, that the task is to be performed remotely by the edge server 106. If the vehicle 102 does have sufficient computing and energy resources to perform the task locally (Yes at step 704), then control passes to step 708.

At step 708, the task performance determination module 416 determines whether the vehicle 102 has sufficient computing and energy resources to encode the data associated with the computational task. If the vehicle 102 does have sufficient resources to encode the data, then control passes to step 710. If the vehicle 102 does not have sufficient resources to encode the data, then control passes to step 712.

At step 710, the task performance determination module 416 determines a latency that would be required for performance of the task remotely by the edge server 106 with encoding of the data associated with the task. In particular, the task performance determination module 416 determines a total time required for the vehicle 102 to encode the data, the vehicle 102 to transmit task information and the encoded data to the edge server 106, the edge server 106 to perform the computational task, and the edge server 106 to transmit the results of the task performance to the vehicle 102. This task performance determination module 416 may determine this latency based on the complexity of the task and the status of the communication channel between the vehicle 102 and the edge server 106.

At step 712, the task performance determination module 416 determines a latency that would be required for performance of the task remotely by the edge server 106 without encoding of the data associated with the task. In particular, the task performance determination module 416 determines a total time required for the vehicle 102 to transmit task information and the un-encoded data to the edge server 106, the edge server 106 to perform the computational task, and the edge server 106 to transmit the results of the task performance to the vehicle 102. This task performance determination module 416 may determine this latency based on the complexity of the task and the status of the communication channel between the vehicle 102 and the edge server 106.

At step 714, the task performance determination module 416 determines a latency that would be required for performance of the task locally by the vehicle 102. At step 716, the task performance determination module 416 selects the lowest latency option between performing the task locally by the vehicle 102, performing the task remotely by the edge server 106 with encoding, and performing the task remotely by the edge server 106 without encoding. However, if the vehicle 102 does not have sufficient resources to encode the data, then performing the task remotely with encoding may not be selected.

At step 718, the model determination module 418 determines an appropriate model or algorithm to perform the computational task based on the type of task to be performed. Then, at step 720, the data transmission module 420 transmits, to the vehicle 102, information about which entity is to perform the task (the vehicle 102 or the edge server 106), whether data is to be encoded, and which model or algorithm should be used to perform the task.

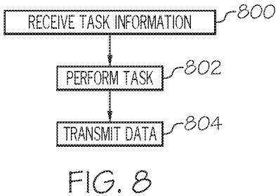

FIG. 8 depicts a flowchart of an example method that may be performed by the edge server 106. At step 800, the task information reception module 512 receives task information from the vehicle 102. The task information may include information about the task to be performed as well encoded or un-encoded data associated with the task. The task information may also include the model or algorithm to be used to perform the task.

At step 802, the task performance module 514 performs task utilizing the indicated model or algorithm and the received data. Then, at step 804, the data transmission module 516 transmits the results of the task performance to the vehicle 102.

It should now be understood that embodiments described herein are directed to edge-assisted energy-aware and communication-aware dynamic computational task offloading strategy. In particular, the techniques disclosed herein allow an autonomous or semi-autonomous vehicle to optimally determine whether computational tasks should be performed locally by the vehicle or remotely by an edge server. As such, the vehicle may increase energy and computing efficiency and reduce latency of performing tasks to be used for performing autonomous or semi-autonomous driving.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method comprising:
receiving task information about a computational task associated with a vehicle to be performed;
receiving information about an amount of gasoline or electrical charge remaining on the vehicle;
determining a complexity of the computational task based on the task information; and
determining whether to perform the computational task locally by the vehicle or remotely by a remote computing device based on the amount of gasoline or electrical charge remaining on the vehicle and the complexity of the computational task.

2. The method of claim 1, further comprising:
receiving a current location and a destination of the vehicle;
determining an amount of gasoline or electrical charge to be used by the vehicle to reach the destination based on the current location;
determining an amount of energy required for the vehicle to perform the computational task;
determining whether the amount of gasoline or electrical charge is sufficient for the vehicle to reach the destination and perform the computational task; and
upon determination that the amount of gasoline or electrical charge is not sufficient for the vehicle to reach the destination and perform the computational task, determining to perform the computational task remotely by the remote computing device.

3. The method of claim 1, further comprising determining a model to be used to perform the computational task based on the task information.

4. The method of claim 1, further comprising, upon determination to perform the computational task remotely by the remote computing device:
transmitting a signal to the vehicle indicating that the computational task is to be performed remotely by the remote computing device;
receiving data associated with the computational task;
performing the computational task using the received data; and
transmitting a result of the computational task to the vehicle.

5. The method of claim 1, further comprising determining the complexity of the computational task based on a look-up table.

6. The method of claim 1, further comprising:
determining a first latency for the vehicle to perform the computational task locally by the vehicle;
determining a second latency for the remote computing device to perform the computational task remotely by the remote computing device;
determining whether the first latency is greater than the second latency;
upon determination that the first latency is greater than the second latency, determining to perform the computational task remotely by the remote computing device; and
upon determination that the first latency is not greater than the second latency, determining to perform the computational task locally by the vehicle.

7. The method of claim 6, further comprising:
receiving a data transmission rate for transmitting data between the vehicle and the remote computing device; and
determining the second latency based at least in part on the data transmission rate.

8. The method of claim 7, further comprising:
determining a first amount of data associated with the computational task;
determining a second amount of data associated with a result of the computational task;
determining a first time for transmitting the data associated with the computational task from the vehicle to the remote computing device based on the first amount of data and the data transmission rate;
determining a second time for the remote computing device to perform the computational task based on the complexity of the computational task;
determining a third time for transmitting the data associated with the result of the computational task from the remote computing device to the vehicle based on the second amount of data and the data transmission rate; and
determining the second latency based on the first time, the second time, and the third time.

9. The method of claim 1, further comprising:
determining a first latency for the vehicle to perform the computational task locally by the vehicle;
determining a second latency for the remote computing device to perform the computational task remotely by the remote computing device using encoded data;
determining a third latency for the remote computing device to perform the computational task remotely by the remote computing device using un-encoded data;
comparing the first latency, the second latency, and the third latency; and
determining one of performing the computational task locally by the vehicle, performing the computational task remotely by the remote computing device with encoded data, and performing the computational task remotely by the remote computing device with un-encoded data based on the comparison.

10. A computing device comprising one or more processors configured to:
receive task information about a computational task associated with a vehicle to be performed;
receive information about an amount of gasoline or electrical charge remaining on the vehicle;
determine a complexity of the computational task based on the task information; and
determine whether to perform the computational task locally by the vehicle or remotely by a remote computing device based on the amount of gasoline or electrical charge remaining on the vehicle and the complexity of the computational task.

11. The computing device of claim 10, wherein the one or more processors are further configured to:
receive a current location and a destination of the vehicle;
determine an amount of gasoline or electrical charge to be used by the vehicle to reach the destination based on the current location;
determine an amount of energy required for the vehicle to perform the computational task;
determine whether the amount of gasoline or electrical charge is sufficient for the vehicle to reach the destination and perform the computational task; and
upon determination that the amount of gasoline or electrical charge is not sufficient for the vehicle to reach the destination and perform the computational task, determine to perform the computational task remotely by the remote computing device.

12. The computing device of claim 10, wherein the one or more processors are further configured to determine a model to be used to perform the computational task based on the task information.

13. The computing device of claim 10, wherein the one or more processors are further configured to, upon determination to perform the computational task remotely by the remote computing device:
transmit a signal to the vehicle indicating that the computational task is to be performed remotely by the remote computing device;
receive data associated with the computational task;
perform the computational task using the received data; and
transmit a result of the computational task to the vehicle.

14. The computing device of claim 10, wherein the one or more processors are further configured to determine the complexity of the computational task based on a look-up table.

15. The computing device of claim 10, wherein the one or more processors are further configured to:
determine a first latency for the vehicle to perform the computational task locally by the vehicle;
determine a second latency for the remote computing device to perform the computational task remotely by the remote computing device;
determine whether the first latency is greater than the second latency;
upon determination that the first latency is greater than the second latency, determine to perform the computational task remotely by the remote computing device; and
upon determination that the first latency is not greater than the second latency, determine to perform the computational task locally by the vehicle.

16. The computing device of claim 15, wherein the one or more processors are further configured to:
receive a data transmission rate for transmitting data between the vehicle and the remote computing device; and
determine the second latency based at least in part on the data transmission rate.

17. The computing device of claim 16, wherein the one or more processors are further configured to:
determine a first amount of data associated with the computational task;
determine a second amount of data associated with a result of the computational task;
determine a first time for transmitting the data associated with the computational task from the vehicle to the remote computing device based on the first amount of data and the data transmission rate;
determine a second time for the remote computing device to perform the computational task based on the complexity of the computational task;
determine a third time for transmitting the data associated with the result of the computational task from the remote computing device to the vehicle based on the second amount of data and the data transmission rate; and
determine the second latency based on the first time, the second time, and the third time.

18. The computing device of claim 10, wherein the one or more processors are further configured to:
determine a first latency for the vehicle to perform the computational task locally by the vehicle;
determine a second latency for the remote computing device to perform the computational task remotely by the remote computing device using encoded data;
determine a third latency for the remote computing device to perform the computational task remotely by the remote computing device using un-encoded data;
compare the first latency, the second latency, and the third latency; and
determine one of performing the computational task locally by the vehicle, performing the computational task remotely by the remote computing device with encoded data, and performing the computational task remotely by the remote computing device with un-encoded data based on the comparison.

19. A system comprising:
a vehicle;
a road-side unit; and
an edge server, wherein
the vehicle is configured to transmit, to the road-side unit, task information about a computational task associated with the vehicle to be performed, and an amount of gasoline or electrical charge remaining on the vehicle; and
the road-side unit is configured to determine a complexity of the computational task based on the task information, and determine whether to perform the computational task locally by the vehicle or remotely by the edge server based on the amount of gasoline or electrical charge remaining on the vehicle and the complexity of the computational task.

20. The system of claim 19, wherein:
upon determination to perform the computational task remotely by the edge server, the road-side unit is configured to transmit a signal to the vehicle indicating that the computational task is to be performed remotely by the edge server;
the vehicle is configured to transmit the task information and data associated with the computational task to the edge server; and
the edge server is configured to perform the computational task using the data associated with the computational task, and transmit a result of the computational task to the vehicle.
